(19) United States
(12) Patent Application Publication
(10) Pub. No.: US 2007/0204173 A1
(43) Pub. Date: Aug. 30, 2007

(54) CENTRAL PROCESSING UNIT AND ENCRYPTED PIN PAD FOR AUTOMATED TELLER MACHINES

(75) Inventor: Jason Kuhn, Painesville, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: WRG SERVICES INC., Willoughby, OH (US)

(21) Appl. No.: 11/675,221

(22) Filed: Feb. 15, 2007

Related U.S. Application Data
(60) Provisional application No. 60/773,485, filed on Feb. 15, 2006.

(51) Int. Cl. G06F 12/14

(52) U.S. Cl. 713/194

(57) ABSTRACT

A system and method for securing a central processing unit and/or encrypting pin pad (EPP) for an automated teller machine from tampering is disclosed. A user input is provided that has a plurality of input keys for allowing associated users to enter information by depressing the input keys. The input keys include key contacts and conductive traces that lead to a processing unit and other security features. In general operation, the key contacts and traces are measured and/or read for capacitance and resistance and are compared against prior readings to establish base for next sequences. If base readings are significantly out of tolerance or if other security features generate a fault condition, a tamper response is triggered, which causes erasing (e.g., zeroing) of cryptographic information contained in the security processor and renders unit inoperable.

### RELATED APPLICATION DATA

This application claims priority from provisional application Ser. No. 60/773,485 filed on Feb. 15, 2006, which is incorporated by reference.

### BACKGROUND

The present invention relates generally to improving security in automated teller machines. In particular, aspects of the present invention relate to a system and method for securing a central processing unit and/or an encrypting pin pad (EPP) for an automated teller machine from tampering by detecting changes in capacitance and/or resistance.

Consumers are using credit cards, debit cards, smart cards, bank cards and other private issued financial cards at an ever increasing rate. With this increase, the need for retailers and businesses to prevent unauthorized access to confidential information and the fraudulent use of confidential information has dramatically increased. Traditionally, security of transaction data associated with automated teller machines has been maintained through the use of various encryption techniques.

Current trends in the industry also call for the pin entry device (e.g., keypad) and/or EPP to also be secured from tampering. The particular requirements set forth in ANSI specification X9.24 and Payment Card Industry (PCI), which are incorporated by reference as if fully rewritten herein. In particular, the X9.24 ANSI standard identifies a tamper resistant security module (TRSM) that may be used for key management in addition to implementing the 3DES encryption algorithm.

According to the X9.24 standard, a TRSM is a device with physical characteristics that makes successful tampering difficult and improbable. A TRSM is required to have physical characteristics that inhibit the determination of any secret data including any past, present, or future key. A TRSM must have physical and functional (logical) characteristics that, in combination, preclude the determination of any key used by the device to encrypt or decrypt secret data. To preclude the determination of any key used by the device to encrypt or decrypt secret data, the TRSM must use one or both of the following methods, in combination with appropriate security procedures: physical barriers or unique key per transaction. All TRSMs are required to have features that resist successful tampering. Tampering includes but not limited to, penetration without zeroization of security data including encryption keys, unauthorized modification of the TRSMs internal operation, or insertion of tapping mechanisms or non-intrusive eavesdropping methods to determine, record, or modify secret data.

Such features are required to include one or more of the following: 1) the TRSM includes means that detect attempted tampering and thereupon cause the automatic erasure of all clear text material contained in the device. The tamper detection must be active regardless of the power state of the TRSM; 2) the TRSM is constructed with physical barriers that makes successful tampering infeasible; 3) the TRSM is sufficiently resistant to tampering and that successful tampering requires an extended time, such that the absence of the TRSM from its authorized location, or its subsequent return to this location, has a high probability of being noted before the device is again used for cryptographic operations; 4) the TRSM is constructed in such a way that successful tampering causes visible damage to the device that has a high probability of being noted after the device has been returned to its authorized location, but before it is again used for cryptographic operations; and 5) the TRSM is constructed in such a way that it is not feasible to modify individual or groups of bits in keys stored in the TRSM; and 5) the TRSM is payment card industry (PCI) compliant.

In addition, TRSMs must prevent the disclosure of any key that has been used to encrypt or decrypt secret data, including other keys (referred to herein as cryptographic information). TRSMs that retain any such key require compromise prevention. Such a TRSM must be designed to be tamper proof by employing physical barriers so that there is a negligible probability of tampering that could successfully disclose such a key. TRSMs that do not retain any such key require only compromise detection and may be less tamper resistant. Compromise of a key resident in such a TRSM does not disclose previously encrypted data, but it is necessary to prevent the future use of any such key in the event that the TRSM is suspected of being compromised. Since any key that might be disclosed by the compromise has not yet been used, it is only necessary to ensure that this key is never used (except by chance).

There is strong need in the art for improved systems and methods to detect intrusion and/or tampering of a central processing unit and/or EPP for automated teller machines.

### SUMMARY OF THE INVENTION

Aspects of the present invention are directed to a method and system for securing a central processing unit and/or an encrypting PIN (personal identification number) pad (EPP) from tampering by sensing capacitance and resistance associated with input keys and conductive traces. When capacitance and/or resistance measurements are outside a predetermined range and/or threshold, all cryptographic information is erased thereby rendering the central processing unit and/or the EPP inoperable.

Another aspect of the invention relates a method for securing a central processing unit of an automated teller machine and/or an EPP from tampering, the method comprising: providing a user input device having a plurality of input keys for allowing associated users to enter information by depressing the input keys, wherein the input keys include key contacts having an associated capacitance and an associated resistance; detecting a first capacitance and first resistance associated with the key contacts; storing the first capacitance and first resistance; detecting a second capacitance and a second resistance at a predetermined time from the step of detecting the first capacitance and first resistance; processing the first and second capacitances and first and second resistances to determine if the capacitance and/or resistance is within a threshold range.

Another aspect of the invention relates to a system for securing a central processing unit and/or an EPP of an automated teller machine from tampering, the system comprising: a user input device having a plurality of input keys for allowing associated users to enter information by depressing the input keys, wherein the input keys include key contacts having an associated capacitance and resistance; a processor coupled to the key contacts for detecting capacitance and resistance of the key contacts; memory coupled to the processor, wherein the memory includes cryptographic information stored therein; and a tamper trigger, wherein when a change in capacitance and/or resistance is detected above and/or below a threshold value, the cryptographic information is erased from memory.

Another aspect of the invention relates to a method for securing a central processing unit and/or an EPP of an automated teller machine from tampering, the method comprising: providing a user input device having a plurality of input keys for allowing associated users to enter information by depressing the input keys, wherein the input keys include circuitry having a capacitance and a resistance; detecting capacitance and resistance from the circuitry at predetermined time intervals; and processing the detected capacitance and resistance to determine if the capacitance and/or resistance is above and/or below a predetermined range.

Another aspect of the invention relates to a method for securing a central processing unit and/or an EPP of an automated teller machine from tampering, the method comprising: detecting at least one of a capacitance and/or a resistance associated with a user input device; monitoring the capacitance and resistance at predetermined intervals to determine that at least one of a capacitance and/or resistance is within a predetermined range; disabling the central processing unit when the at least one of a capacitance and/or resistance is outside the predetermined range.

Another aspect of the invention relates to a central processor unit for an automated teller machine comprising: a display; a user input device for interactively entering information by an associated user, wherein the user input device includes a plurality key contact having an associated capacitance and resistance; a central processing unit for controlling the display and the user input device; a main power supply providing power to at least one of the display, the user input device or the central processing unit; a security processing unit for protecting the central processing unit from a tamper event, wherein the security processing unit stores cryptographic information and the security processing unit is coupled to the user input device and the central processing unit; and the security processing unit detects the capacitance and resistance of the plurality of key contacts at predetermined times to determine if the capacitance and/or resistance is within a predetermined range.

Another aspect of the invention includes the user input device having a plurality of hold down keys for detecting when the central processing unit has been opened.

Another aspect of the invention includes the hold down keys having a grounded outer ring.

Another aspect of the invention includes the numeric keypad being recessed from the face of the housing.

Another aspect of the invention includes a change in temperature above and/or below a threshold temperature causing cryptographic information to be erased and the unit being rendered inoperable.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

### A BRIEF DESCRIPTION OF THE DRAWINGS

FIG. 1 is a perspective view of an exemplary central processing unit for automated teller machines in accordance with aspects of the present invention.

FIG. 2 is a front view of the exemplary central processing unit illustrated in FIG. 1.

FIG. 3 is a schematic diagram of the central processing unit illustrated in FIG. 1.

FIG. 4 is a schematic diagram of exemplary capacitance and resistance sensors in accordance with aspects of the present invention;

FIGS. 5, 6 and 7 are exemplary methods in accordance with aspects of the present invention.

### DETAILED DESCRIPTION OF THE INVENTION

In the detailed description that follows, corresponding components have been given the same reference numerals, regardless of whether they are shown in different embodiments of the present invention. To illustrate the present invention in a clear and concise manner, the drawings may not necessarily be to scale.

Aspects of the present invention relate to a system and method for securing a central processing unit and/or encrypting PIN pad (EPP) for an automated teller machine from tampering. A user input is provided that has a plurality of input keys for allowing associated users to enter information by depressing the input keys. The input keys include key contacts and conductive traces that lead to a processing unit. In general operation, the key contacts and traces are measured and/or read for capacitance and resistance and are compared against prior readings to establish base values for further sequences of measurements. If base readings are significantly out of tolerance (e.g., outside a predetermined range and/or threshold), a warning flag is set. If more than a predetermined amount of readings (e.g., three) are significantly out of tolerance, a tamper response is triggered, which causes erasing (e.g., zeroing) of cryptographic information contained in the security processor and renders the unit inoperable.

A control algorithm serially cycles all input keys and/or traces and senses and/or otherwise measures the respective capacitance and resistance to each of the input keys and/or traces. During each cycle, a measurement of one resonant-capacitance (RC) time constant is made. If the time constant is out of tolerance from the prior reading, a warning flag is set. If more than three readings are significantly out of tolerance, the tamper response is triggered, causing immediate zeroing of cryptographic information contained in the processor and renders the unit inoperable. The control algorithm allows for gradual temperature induced changes in the capacitance and resistance.

Aspects of the invention also relate to an EPP. Typically, EPPs are used to enter a cardholder's PIN in a secure manner. EPPs are used in conjunction with ATMs, automated fuel dispensers, point of sale devices, kiosks, and vending machines.

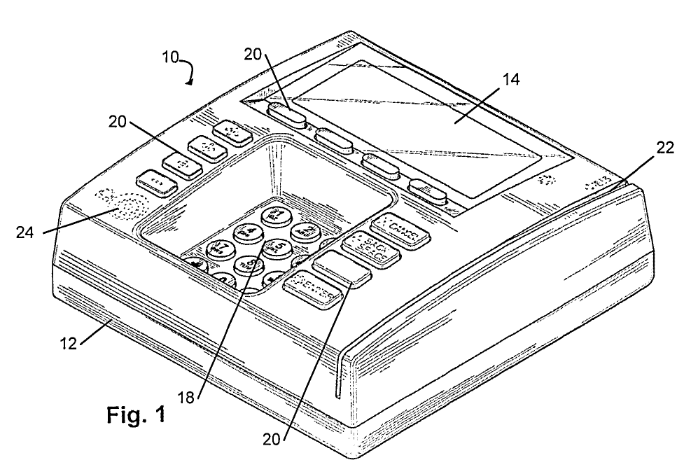

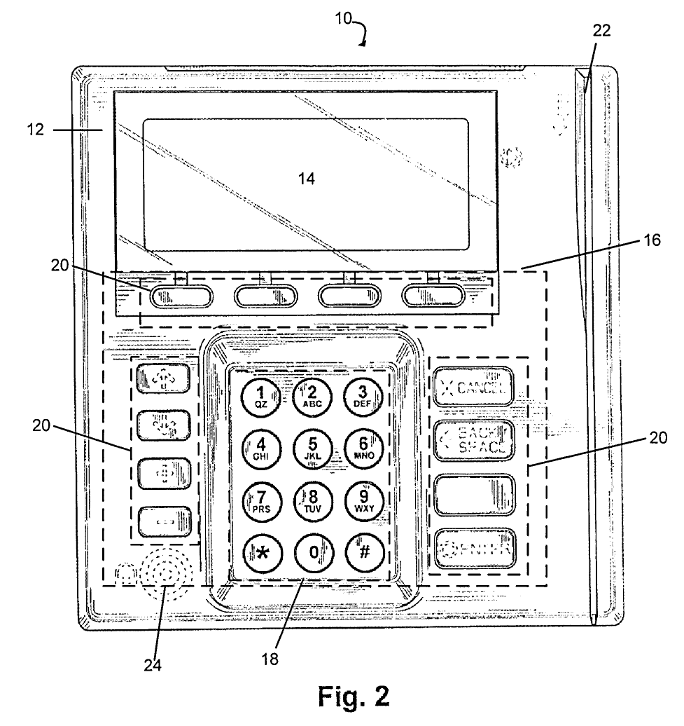

An exemplary central processing unit 10 for an automated teller machine is illustrated in FIGS. 1 and 2. The central processing unit 10 includes a housing 12, a display 14, a user input device 16 with numeric keys 18 and function keys 20, a slot 22 for receiving a card with a magnetic strip and a headphone jack 24. The central processing unit 10 provides a convenient way for consumers to retrieve cash from an automated teller machine (ATM), purchase goods or services through an ATM by using a credit or debit card without the need for carrying currency. The central processing unit also provides those selling goods and services a quick and convenient way to obtain credit authorization from the financial institution issuing the consumer's credit or debit card.

The housing 12 is generally manufactured from a durable material such as plastic and/or metal. The housing 12 is generally self-contained and contains all of the hardware and software necessary to carryout the functions described herein. The housing 12 houses the display 14. The display 14 generally provides a convenient user interface to an associated user that desires to use the central processing unit 10. The display 14 presents information to a user such as operating state of the ATM, queries, information, withdrawal amounts, deposit amounts, various navigational menus, user information, available services and/or products, etc., which generally enable the user to utilize the various features and/or applications of the central processing unit 10.

The user input device 16 is also housed in the housing 12. The housing 12 has a portion that is recessed from the front face of the central processing unit 10 to receive the numeric keys 18. As shown in FIG. 1, the recessed housing prevents on-lookers and/or eavesdroppers from viewing the user of the ATM when the user is entering information with the numeric keys 18 (e.g., a user PIN, withdrawal and/or deposit amounts, etc.). The user input device 16 also may include larger key pads on the numeric keys 18 and/or the function keys 20 than conventional ATMs to facilitate use of the ATM by elderly persons, as well as persons with disabilities. The user input device 16 provides for a variety of user input operations. For example, the user input device 16 includes numeric keys 18 for entry of personal identification numbers, deposit amounts, withdrawal amounts, etc. In addition, the user input device 16 may include special function keys 20 such as, for example, a “cancel”, “enter”, navigation keys, mathematical functions (e.g., addition and subtraction), volume keys, etc. In general operation, when the keys associated with the user input device 16 are depressed by an associated user, the corresponding key function and/or value is entered and a corresponding display prompt may be updated to inform the user of which keys were entered. As one of ordinary skill in the art will appreciate keys or key-like functionality may also be embodied as a touch screen associated with the display 14.

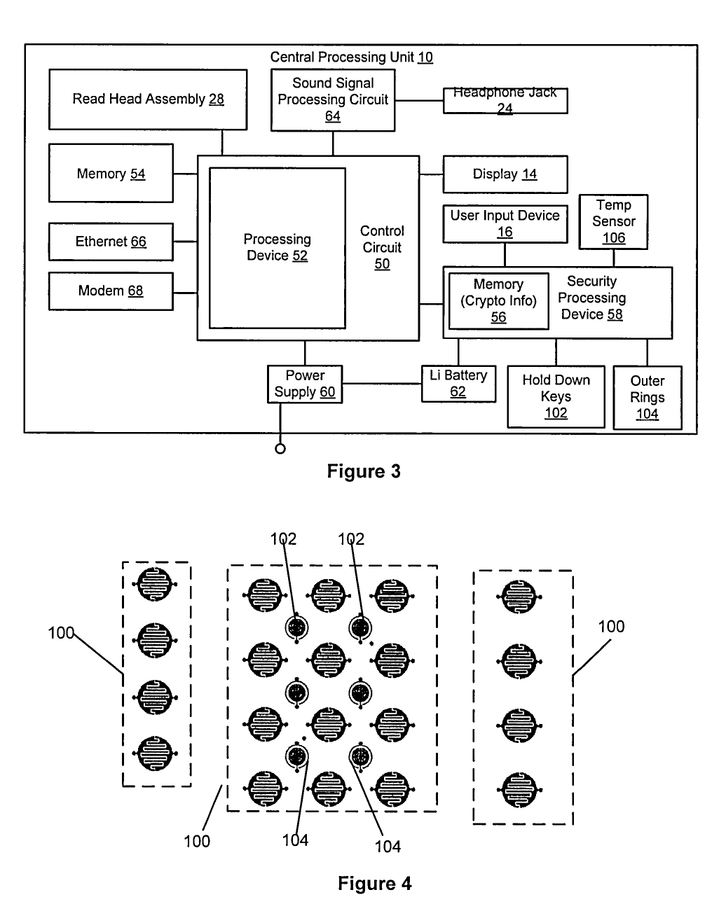

The housing 12 includes a slot 22 that is sized to facilitate swiping of a credit card, debit card or any other type of card that has a magnetic strip. A read head assembly 28 (shown in FIG. 3) is mounted to the housing 12. The read head assembly 28 generally includes a sensor that reads the information contained on a magnetic strip of an associated card and converts the information for use by the central processing unit 10.

The central processing unit 10 may also include associated electronics to audibly output information to an associated user. In addition, the central processing unit 10 may also include a headphone jack 24 to facilitate use of the ATM by users with one or more physical disabilities.

Referring to FIG. 3, a functional block diagram of the central processing unit 10 is illustrated. The central processing unit 10 includes a primary control circuit 50 that is configured to carry out overall control of the functions and operations of the central processing unit 10. The control circuit 50 may include a processing device 52, such as a CPU, microcontroller or microprocessor. The processing device 52 executes code stored in a memory (not shown) within the control circuit 50 and/or in a separate memory, such as memory 54, in order to carry out operation of the central processing unit 10.

The memory 54 may be any suitable storage device (e.g., a buffer, a flash memory, a hard drive, a removable media, a volatile memory and/or a non-volatile memory, etc.). The memory 54 is operable to store any desired information, including for example, control algorithms, security algorithms, etc. Generally, the memory 54 does not store user information and/or transaction information. As discussed below, such information is generally stored in the memory 56 that is housed and/or coupled to the security processing device 58 for storing cryptographic information.

The security processing device 58 is coupled to the user input device 16 and the control circuit 50. The user input device 16 is coupled to the security processing device through key contacts 100 (shown in FIG. 4) and conductive traces. In addition to registering the information entered by the user, the key contacts 100 function as sensors. For example, key contacts 100 generally have a voltage applied and have an associated capacitance and resistance that may be individually measured by the security processing device 58. The key contacts 100 generally are positioned to match the position of the numeric keys 18 and/or function keys 20.

Referring to FIG. 4, in addition to key contacts 100, hold down keys 102 are also illustrated. The hold down keys 102 are electrically coupled to the security processing device 58. In operation, the hold down keys 102 are held in a compressed state between the printed circuit board and the housing 12. A rubber actuator (not shown) may be used to allow for expansion and/or position variability due inconsistencies in components and/or thermal expansion. When the housing 12 of the unit 10 is opened, the hold down keys 102 extend to relaxed state, which causes a fault to be detected by the security processing device 58 and triggers a tamper response. The hold down keys 102 also include outer rings 104 that surround the hold down keys 102. The outer rings 104 are generally gold plated contacts. If a tamper attempt occurs near the numeric keys 18, the outer rings 104 are grounded to the corresponding hold down key 102 and a tamper response is triggered.

The key contacts 100 and conductive traces are coupled to the security processing device 58 and are read for capacitance and resistance. An algorithm electronically housed in the security processing device 58 generally monitors the key contacts 100 for capacitance and resistance values to determine whether a tamper response should be triggered. In addition, the hold down keys 102 and outer rings 104 are also monitored by the security processing device 58 to determine whether a tamper response should be triggered.

Tamper responses include, for example, disabling the entire central processing unit 10, erasing cryptographic information stored in the memory 56 and/or security processing device 58, etc. One of ordinary skill in the art will readily appreciate that there a variety of criteria to determine whether a tamper response should be initiated, all such criteria are deemed to be within the scope of the invention.

In one embodiment of the invention, an algorithm stored in the security processing device 58 periodically measures capacitance and resistance of each of the key contacts 100. The measurements are compared against prior readings to establish a base comparison value for the next sequence of measurements. If the base readings are significantly out of tolerance (e.g., outside a predetermined range and/or threshold, a warning flag may be set. If more than a predetermined number of readings (e.g., three readings) are significantly out of tolerance, a tamper response may be triggered. Preferably, the tamper response will generally include erasing the cryptographic information contained in memory 56 of the security processing device 58.

The algorithm also monitors the status of the hold down keys 102 and outer rings, as well as, temperature which is measured through a temperature sensor 106 (e.g., thermometer) coupled to the security processing device 58, to determine whether a tamper response should be triggered. For example, if the hold down keys 102 extend to a relaxed state and/or the outer rings 104 are shorted to the hold down keys 104, a tamper event is triggered.

Measurements for the key contacts 100 may be taken at any desired time. Exemplary timing events include, for example: measuring active physical security measures every one second; key verification of all keys and security data is performed every 10 seconds; and unit temperature is checked every second.

A variety of other security protections are built-in unit 10. For example, the security processing device memory (firmware) 56 is cyclic redundancy checked (CRC) to detect errors after transmission or storage every twelve hours; if the temperature of the unit 10 is below −20° C. or above 70° C., a tamper response will be initiated; and messages between the main processing device 52 and the security processing device 58 are authenticated prior to every message. In addition, the main processor firmware and system files (e.g., prompt file) are authenticated every 22 hours using 3DES MAC (message authenticated code). If a 24-hour period occurs since the last authentication, a fault will occur that generates a tamper response. Likewise, if the authentication fails for any of the events listed above, a fault state is entered and a tamper response will be generated. In addition, if the security processing device 58 is reset for any reason (including a power fault), a fault will occur that generates a tamper response.

In addition, at power-up and at predetermined times, the unit 10 will undergo a variety of self tests. If any of the self tests generate a fault, a tamper event will be generated that results in the active deletion of key data by overwriting with zero's, and will cause the security processing device 58 to enter a tamper state, wherein all sensitive commands are disabled and the unit is rendered inoperable. Such an event will also cause the creation of a log in a non-volatile EEPROM memory (not shown) inside the security processing device 58 that identifies the cause of the fault and the time at which the fault occurred.

Preferably, an entire cycle of key contacts are taken at one RC time constant is made. If the time constant is out of tolerance (e.g., outside a predetermined range and/or threshold) from the prior reading, a warning flag is set. If a predetermined number of reads (e.g., three) are significantly out of tolerance, a tamper response will be triggered. Due to the environment that an automated teller machine may be placed, the algorithm allows for gradual temperature induced changes in the capacitance and resistance of the key contacts. Sudden changes in temperature will cause the triggering of the tamper response, which includes zeroing of all cryptographic information contained within the security processor.

Referring back to FIG. 3, the main power supply unit (PSU) 60 of the central processing unit 10 generally provides power to all of the electrical components of the unit 10. In addition, the PSU 60 is coupled to a battery 62 to provide battery back-up to the security processing device 58 if power is lost, but a tamper event has not been detected. The central processing unit 10 may include a sound signal processing circuit 64 for processing audio signals output by the unit 10 through the headset interface 24, which enables a user to listen to output from the unit 10.

The central processing unit 10 further includes a variety of interfaces that allow other electronic devices to interface with the unit 10. The interfaces include an Ethernet adapter 66 and a modem 68. As shown in FIG. 3, the interfaces are generally coupled to the control circuit 50, which generally controls operation of the interfaces.

General operation of the security functions of the central processing unit 10 will now be discussed. The exemplary methods listed below may be performed in software, hardware, firmware and/or any combination of software, hardware and/or firmware.

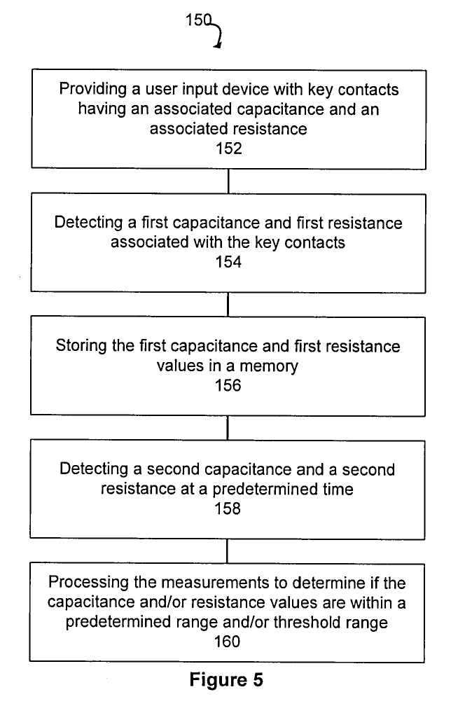

An exemplary method 150 for securing a central processing unit of an automated teller in accordance with aspects of the invention is shown in FIG. 5. The method 150 includes at step 152 providing a user input device having a plurality of input keys for allowing associated users to enter information by depressing the input keys, wherein the input keys include key contacts having an associated capacitance and an associated resistance. At step 154, a first capacitance and first resistance associated with the key contacts is detected. At step 156, the first capacitance and first resistance values are stored in a memory. At step 158, a second capacitance and a second resistance is detected at a predetermined time from the step of detecting the first capacitance and first resistance. At step 160, the first and second capacitances and first and second resistances are processed to determine if the capacitance and/or resistance values are within a predetermined range and/or threshold range.

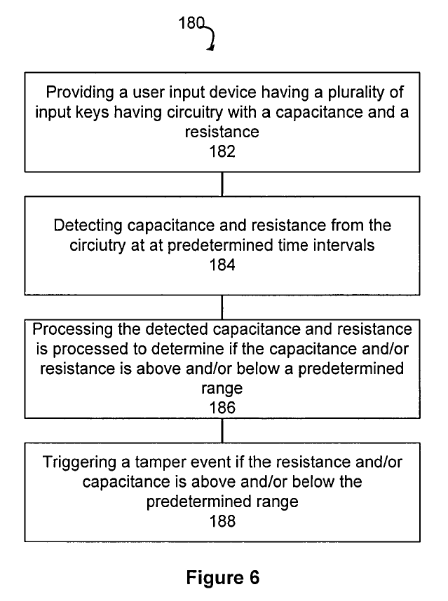

Another exemplary method 180 for securing a central processing unit of an automated teller machine from tampering is illustrated in FIG. 6. At step 182, a user input device having a plurality of input keys for allowing associated users to enter information by depressing the input keys is provided, wherein the input keys include circuitry having a capacitance and a resistance. At step 184, capacitance and resistance from the circuitry detected at predetermined time intervals. At step 186, the detected capacitance and resistance is processed to determine if the capacitance and/or resistance is above and/or below a predetermined range. At step 188, a tamper event is triggered if the resistance and/or capacitance is above and/or below the predetermined range.

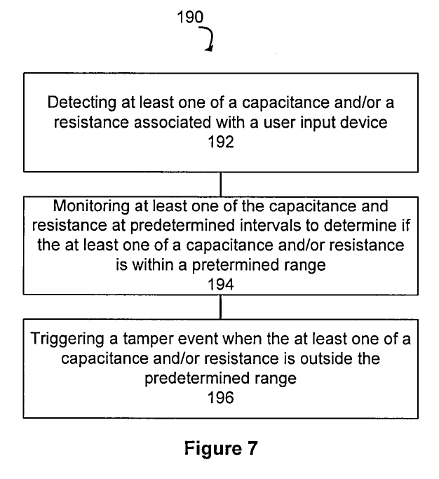

Another exemplary method 190 for securing a central processing unit of an automated teller machine from tampering is illustrated in FIG. 7. At step 192, at least one of a capacitance and/or a resistance associated with a user input device is detected. At step 194, the at least one of the capacitance and resistance is monitored at predetermined intervals to determine if the at least one of a capacitance and/or resistance is within a predetermined range. At step 196, triggering a tamper event when the at least one of a capacitance and/or resistance is outside the predetermined range.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method for securing a central processing unit and/or encrypting PIN pad of an automated teller machine from tampering, the system comprising:
providing a user input device having a plurality of input keys for allowing associated users to enter information by depressing the input keys, wherein the input keys include key contacts having an associated capacitance and an associated resistance;
detecting a first capacitance and first resistance associated with the key contacts;
storing the first capacitance and first resistance;
detecting a second capacitance and a second resistance at a predetermined time from the step of detecting the first capacitance and first resistance;
processing the first and second capacitances and first and second resistances to determine if the capacitance and/or resistance is within a threshold range.

2. The method of claim 1 further including triggering a tamper response if the first and second capacitances and/or first and second resistances are outside of the threshold range for a predetermined number of calculations.

3. The method of claim 2, wherein the predetermined number of calculations is three.

4. The method of claim 2, wherein the tamper response is erasing cryptographic information stored in a memory.

5. The method of claim 2, wherein the tamper response is erasing cryptographic information stored in a processor.

6. The method of claim 2, wherein the tamper response is disabling a portion of the central processing unit.

7. The method of claim 1, wherein the predetermined time is a product of the resistance and the capacitance of the key contact.

8. The method of claim 1, wherein the threshold range is determined by an algorithm that allows for gradual temperature induced changes in the capacitance and resistance associated with the key contact.

9. The method of claim 1, wherein the capacitance and resistance for each key contact is detected one after another at a predetermined time constant.

10. The method of claim 9, wherein the time constant of a product of the capacitance and resistance associated with the key contact.

11. A system for securing a central processing unit and/or an encrypting PIN pad of an automated teller machine from tampering, the system comprising:
a user input device having a plurality of input keys for allowing associated users to enter information by depressing the input keys, wherein the input keys include key contacts having an associated capacitance and resistance;
a processor coupled to the key contacts for detecting capacitance and resistance of the key contacts;
a memory coupled to the processor, wherein the memory includes cryptographic information stored therein; and
a tamper trigger, wherein when a change in capacitance and/or resistance is detected above and/or below a threshold value, the cryptographic information is erased from memory.

12. The system of claim 11 further including conductive traces coupling the key contacts to the processor, wherein the conductive traces include an associated capacitance and resistance.

13. The system of claim 12 wherein when a change in capacitance and/or resistance associated with conductive traces is detected above and/or below the threshold value, the cryptographic information is erased from memory.

14. A method for securing a central processing unit of an automated teller machine from tampering, the method comprising:
providing a user input device having a plurality of input keys for allowing associated users to enter information by depressing the input keys, wherein the input keys include circuitry having a capacitance and a resistance;
detecting capacitance and resistance from the circuitry at predetermined time intervals; and
processing the detected capacitance and resistance to determine if the capacitance and/or resistance is above and/or below a predetermined range.

15. The method according to claim 14 further including erasing cryptographic information stored in a memory when the detected capacitance and/or resistance is above and/or below the predetermined range.

16. The method of according to claim 14, wherein the user input device includes a plurality of hold down keys for detecting whether the central processing unit has been opened.

17. The method of according to claim 16, wherein the hold down keys also include a grounded outer ring.

18. A method for securing a central processing unit of an automated teller machine from tampering, the method comprising:
detecting at least one of a capacitance and/or a resistance associated with a user input device;
monitoring the capacitance and resistance at predetermined intervals to determine that the at least one of a capacitance and/or resistance is within a predetermined range;
triggering a tamper event when the at least one of a capacitance and/or resistance is outside the predetermined range.

19. The method of claim 18, wherein the step of triggering a tamper event includes erasing cryptographic information stored in a memory.

20. A central processor unit for an automated teller machine comprising:
a display;
a user input device for interactively entering information by an associated user, wherein the user input device includes a plurality of key contacts having an associated capacitance and resistance;
a central processing unit for controlling the display and the user input device;
a main power supply providing power to at least one of the display, the user input device or the central processing unit;
a security processing unit for protecting the central processing unit from a tamper event, wherein the security processing unit stores cryptographic information and the security processing unit is coupled to the user input device and the central processing unit; and
the security processing unit detects the capacitance and resistance of the plurality of key contacts at predetermined times to determine if the capacitance and/or resistance is within a predetermined range.

21. The unit of claim 20, wherein the cryptographic information stored in the security processing unit is erased if the capacitance and/or resistance fall outside the predetermined range.

22. The unit of claim 21, wherein the cryptographic information stored in the security processing unit is erased if a loss of electrical power is detected from the security processing unit.

23. The unit of claim 23, wherein the user input devices includes a plurality of hold down keys for detecting when the central processing unit has been opened.

24. The unit of according to claim 23, wherein the hold down keys also include a grounded outer ring.

25. The unit according to claim 21, wherein the numeric keypad are recessed from a face of the housing.

26. The unit of claim 20 further including a temperature sensor coupled to the security processing unit.

27. The unit of claim 26, wherein when a change in temperature is above a high threshold temperature and/or below a low threshold temperature, the cryptographic information is erased from memory.

28. A method for securing an encrypted PIN pad (EPP) of an automated teller machine from tampering, the method comprising:
providing a portable user input device having a plurality of input keys for allowing associated users to enter information by depressing the input keys, wherein the input keys include circuitry having a capacitance and a resistance;
detecting capacitance and resistance from the circuitry at predetermined time intervals; and
processing the detected capacitance and resistance to determine if the capacitance and/or resistance is above and/or below a predetermined range.
